(19) United States
(12) Patent Application Publication
(10) Pub. No.: US 2008/0172283 A1
(43) Pub. Date: Jul. 17, 2008

(54) Automatic Reminder for Repeating Calendar Events

(76) Inventors: Moshe Klausner, Ramat Yishay (IL); Boaz Mizrachi, Haifa (IL)

Correspondence Address: IBM CORPORATION, T.J. WATSON RESEARCH CENTER, P.O. BOX 218, YORKTOWN HEIGHTS, NY, 10598, US

(21) Appl. No.: 11/623,759

(22) Filed: Jan. 17, 2007

(51) Int. Cl. G06F 15/02

(52) U.S. Cl. 705/9

(57) ABSTRACT

Managing repeating events in a calendar application, including scheduling a series of repeating events using a calendar application executed by a computer, and configuring the calendar application to provide a reminder announcing the last event in the series as being the last event in the series.

### FIELD OF THE INVENTION

The present invention relates to computer-implemented calendar applications in general, and in particular to management of repeating calendar events.

### BACKGROUND OF THE INVENTION

The computer-implemented calendar application has become an essential business tool. One important feature provided by calendar applications is the ability to schedule repeating events, such as a series of meetings on a particular topic that takes place at the same time on different days. For example, in FIG. 1 a scheduler 104 of a calendar application that is executed by a computer 100 is shown providing a window 102 in which the parameters of a repeating event are entered. As shown in the example, a meeting is scheduled to take place each day for five consecutive days starting from Apr. 27, 2006, between 13:30 pm and 14:30 pm.

Typically, calendar applications provide a reminder manager 106 allowing an entry in a calendar application to be programmed to provide a reminder regarding the event, such as in the form of an audible alarm or a displayed message. Where such reminders are used for repeating calendar events, the same reminder is used for each particular event.

### SUMMARY OF EMBODIMENTS OF THE INVENTION

The present invention in embodiments thereof discloses providing a reminder in connection with the last event in a series of repeating events indicating that the event is the last event in the series. Such a reminder may serve to provide an impetus for event planners to extend the series of events or schedule one or more related events.

In one aspect of the present invention a computer-implemented method is provided for managing repeating events in a calendar application, the method including scheduling a series of repeating events using a calendar application executed by a computer, and configuring the calendar application to provide a reminder announcing the last event in the series as being the last event in the series.

In another aspect of the present invention a computer-implemented method is provided for managing repeating events in a calendar application, the method including receiving an instruction to schedule a series of repeating events, and receiving an instruction to provide a reminder announcing the last event in the series as being the last event in the series.

In another aspect of the present invention a system is provided for managing repeating events in a calendar application, the system including a scheduler for scheduling a series of repeating events using a calendar application executed by a computer, and a reminder manager configured to provide a reminder announcing the last event in the series as being the last event in the series.

### BRIEF DESCRIPTION OF THE DRAWINGS

Embodiments of the present invention will be understood and appreciated more fully from the following detailed description taken in conjunction with the appended drawings in which:

FIG. 1 is a simplified conceptual illustration of a prior art computer-implemented calendar application with repeating event scheduling; and

FIGS. 2, 3, and 4 are simplified conceptual illustrations of computer-implemented calendar application features, constructed and operative in accordance with an embodiment of the present invention.

### DETAILED DESCRIPTION OF EMBODIMENTS OF THE INVENTION

The present invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

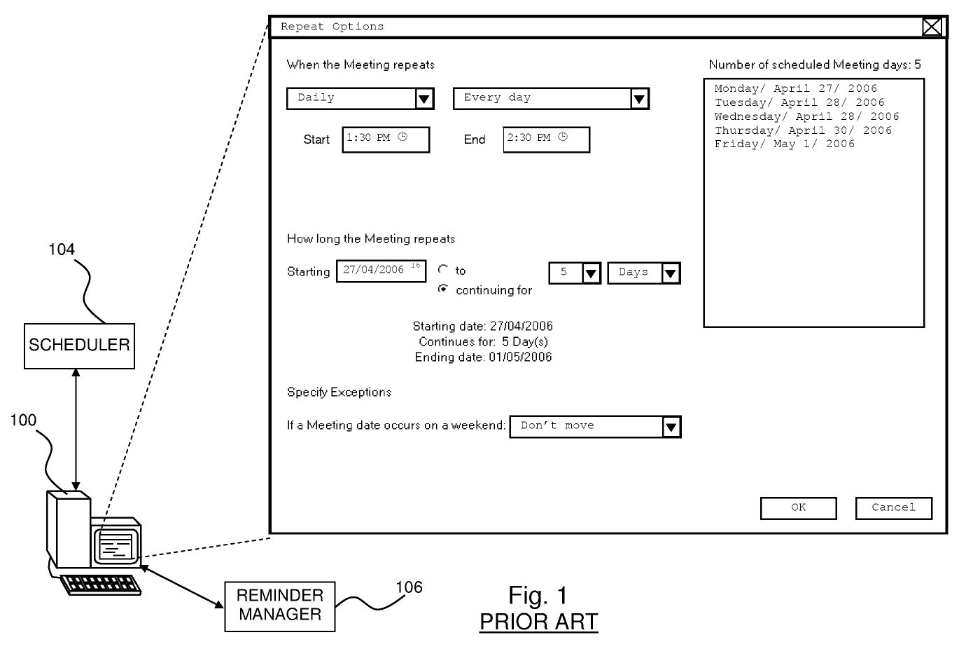

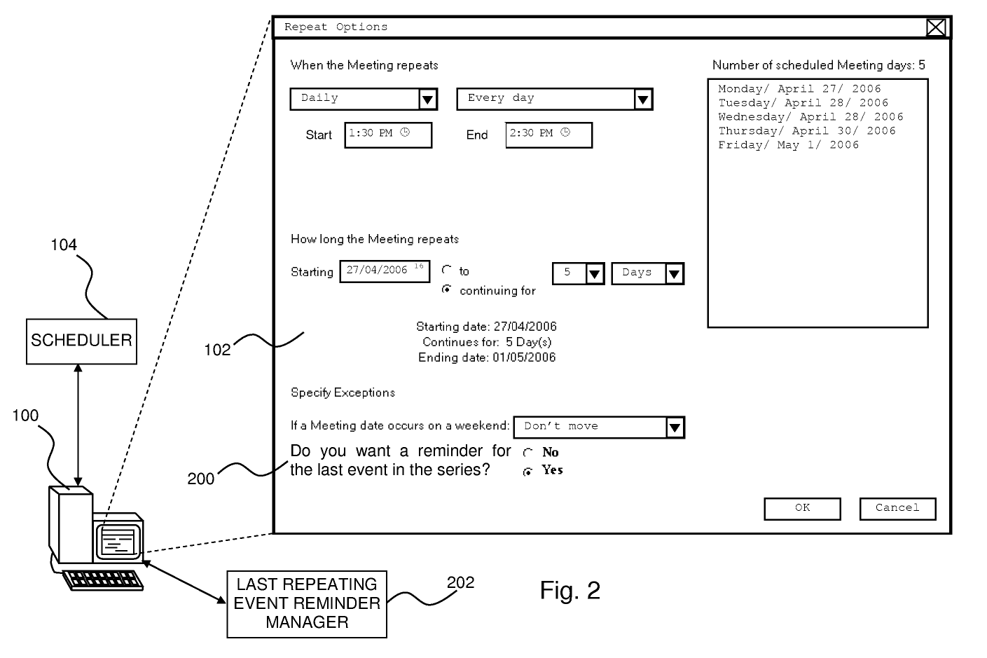

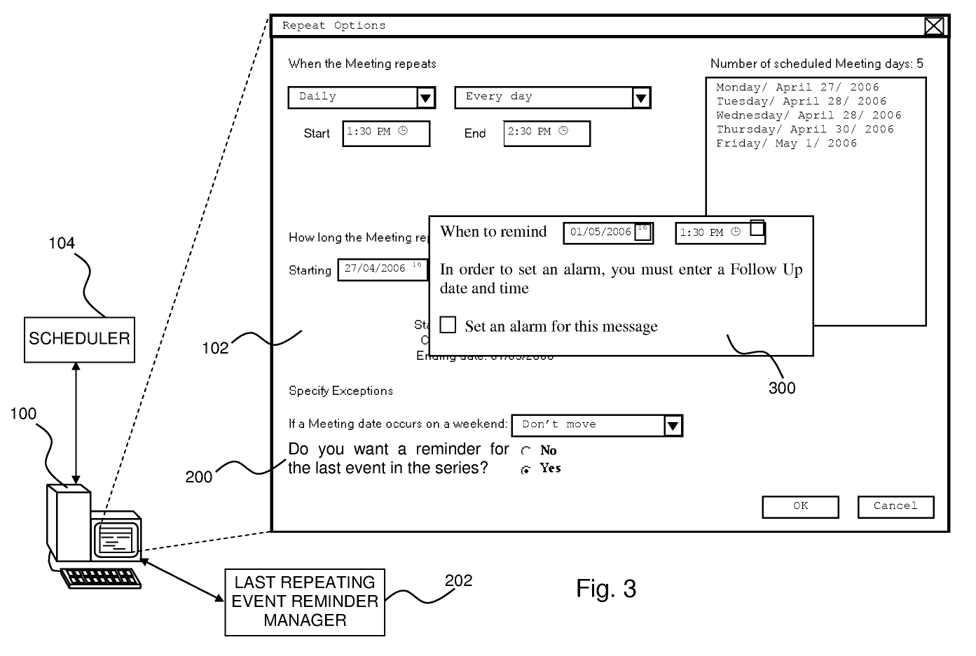

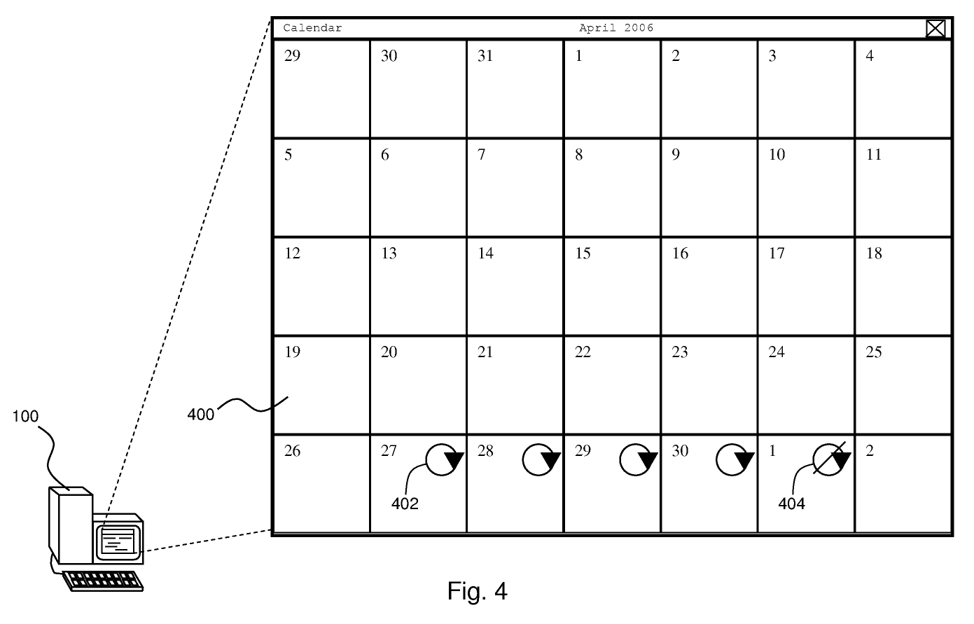

Reference is now made to FIGS. 2, 3, and 4 which are simplified conceptual illustrations of computer-implemented calendar application features, constructed and operative in accordance with an embodiment of the present invention. The repeating event parameters window of FIG. 2 is substantially similar to that of FIG. 1, with the notable exception that a reminder prompt 200 may be provided by a last repeating event reminder manager 202 to the event requester via which the calendar application may be configured to provide a reminder announcing the last event in a series of repeating events as being the last event in the series. If such a reminder is requested, the requester may further indicate when to provide the reminder, such as via a reminder date/time window 300 shown in FIG. 3, via which the calendar application may be configured to provide the reminder at a specific date and time. The requester may also indicate whether an audible alarm should sound in connection with the reminder. A repeating entry may be indicated as such using an indicator, such as an indicator 402 displayed on a calendar 400 shown in FIG. 4, while the last repeating entry in a series may be indicated as such using a different indicator, such as an indicator 404.

The reminder for the last repeating entry may be presented using any conventional technique, such as by displaying a message box with the text “Your repeating entry is about to expire on: dd/mm/yy” or other user-defined text. The reminder may be provided to the creator of the repeating event entry, as well as to the invitees to the repeating events who, upon accepting an invitation received at their own calendar applications on their own computers, or at a common calendar application hosted by a single computer and used by invitor and invitees alike, to attend the repeating event, may use last repeating event reminder manager 202 at their calendar application to be prompted with a reminder prompt, such as reminder prompt 200 (FIG. 2), via which the invitee may configure the invitee's own calendar application to provide a reminder announcing the last event in the series of repeating events, as well as a reminder date/time window, such as reminder date/time window 300 (FIG. 3), via which the invitee may configure the invitee's calendar application to provide the reminder at a specific date and time.

It is appreciated that last repeating event reminder manager 202 may be implemented independently from, or may be incorporated into, any conventional reminder manager, such as reminder manager 106 (FIG. 1).

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

What is claimed is:

1. A computer-implemented method for managing repeating events in a calendar application, the method comprising:
scheduling a series of repeating events using a calendar application executed by a computer; and
configuring said calendar application to provide a reminder announcing the last event in said series as being the last event in said series.

2. The computer-implemented method according to claim 1 and further comprising:
receiving at a calendar application executed by a second computer an invitation to attend said series of repeating events scheduled at said first computer; and
configuring said second computer calendar application to provide a reminder announcing the last event in said series as being the last event in said series.

3. The computer-implemented method according to claim 1 and further comprising:
receiving an invitation via said calendar application to attend said series of repeating events; and
configuring said calendar application to provide a reminder to said invitee announcing the last event in said series as being the last event in said series.

4. A computer-implemented method for managing repeating events in a calendar application, the method comprising:
receiving an instruction to schedule a series of repeating events; and
receiving an instruction to provide a reminder announcing the last event in said series as being the last event in the series.

5. The computer-implemented method according to claim 4 and further comprising displaying an indicator representing any of said repeating entries.

6. The computer-implemented method according to claim 4 and further comprising displaying an indicator representing said last event in said series.

7. A system for managing repeating events in a calendar application, the system comprising:
a scheduler for scheduling a series of repeating events using a calendar application executed by a computer; and
a reminder manager configured to provide a reminder announcing the last event in said series as being the last event in said series.

8. The system according to claim 7 and further comprising:
a second scheduler executed by a second computer and operative to receive an invitation to attend said series of repeating events scheduled at said first computer; and
a second reminder manager executed by said second computer and configured to provide a reminder announcing the last event in said series as being the last event in said series.

9. The system according to claim 7 wherein said scheduler is operative to receive an invitation to attend said series of repeating events, and wherein said reminder manager is operative to configure said calendar application to provide a reminder to said invitee announcing the last event in said series as being the last event in said series.

10. The system according to claim 7 and further comprising displaying an indicator representing any of said repeating entries.

11. The system according to claim 7 and further comprising displaying an indicator representing said last event in said series.
